(19) United States
(12) Patent Application Publication
(10) Pub. No.: US 2026/0222562 A1
(43) Pub. Date: Jul. 30, 2026

(54) Method and Apparatus for Adaptive Loop Filter with Cross-Component Taps for Video Coding

(71) Applicant: MEDIATEK INC., Hsinchu City (TW)

(72) Inventors: Shih-Chun CHIU, Hsinchu City (TW); Yu-Ling HSIAO, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yi-Wen CHEN, San Jose, CA (US); Yu-Wen HUANG, Hsinchu City (TW)

(21) Appl. No.: 19/145,290

(22) PCT Filed: Jan. 5, 2024
(86) PCT No.: PCT/CN2024/070756

§ 371 Date: Jul. 2, 2025

Related U.S. Application Data
(60) Provisional application No. 63/478,706, filed on Jan. 6, 2023.
(60) Provisional application No. 63/479,742, filed on Jan. 13, 2023.
(60) Provisional application No. 63/479,743, filed on Jan. 13, 2023.

(51) Int. Cl. H04N 19/117; H04N 19/186; H04N 19/196; H04N 19/82

(52) U.S. Cl. CPC H04N 19/117; H04N 19/186; H04N 19/196; H04N 19/82

(57) ABSTRACT

Method and apparatus for video coding using ALF (Adaptive Loop Filter) for the chroma component. According to one method, ALF processing is applied to a target colour component of the current block. The ALF processing comprises colour-component ALF processing and cross-component ALF processing, the colour-component ALF processing is applied to the target colour component of the current block to generate the target colour component for a filtered-reconstructed current block, and the cross-component ALF processing is applied to another colour component of the current block to generate across-component adjustment for the target colour component of the filtered-reconstructed current block. Input data related to reconstructed pixels associated with at least two colour components are provided for the colour-component ALF processing and the cross-component ALF processing, and the colour-component ALF processing and the cross-component ALF processing use signalled coefficients.

### CROSS REFERENCE TO RELATED APPLICATIONS

The present invention is a non-Provisional Application of and claims priority to U.S. Provisional Patent Application No. 63/478,706, filed on Jan. 6, 2023, U.S. Provisional Patent Application No. 63/479,742, filed on Jan. 13, 2023 and U.S. Provisional Patent Application No. 63/479,743, filed on Jan. 13, 2023. The U.S. Provisional Patent Applications are hereby incorporated by reference in their entireties.

### FIELD OF THE INVENTION

The present invention relates to video coding system using ALF (Adaptive Loop Filter). In particular, the present invention relates to applying the ALF filter with improved schemes for geometric transform.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i,j) indicates a reconstructed sample at coordinate (i,j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and gd₂ in FIG. 3D).

Then D maximum and minimum values of the gradients of horizontal and vertical directions are set as:

$${g}_{h , v}^{max} = max ( {g}_{h} , {g}_{v} ) ,$$

$${g}_{h , v}^{min} = min ( {g}_{h} , {g}_{v} ) .$$

The maximum and minimum values of the gradient of two diagonal directions are set as:

$${g}_{d 0 , d 1}^{max} = max ( {g}_{d 0} , {g}_{d 1} ) ,$$

$${g}_{d 0 , d 1}^{min} = min ( {g}_{d 0} , {g}_{d 1} ) .$$

To derive the value of the directionality D, these values are compared against each other and with two thresholds t₁ and t₂:

$$Step 1. If both {g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} are true , D is set to 0.$$

$$Step 2. If {g}_{h , v}^{max} / {g}_{h , v}^{min} > {g}_{d 0 , d 1}^{max} / {g}_{d 0 , d 1}^{min} , continue from Step 3 ; otherwise continue from Step 4 .$$

$$Step 3. If {g}_{h , v}^{max} > {t}_{2} \cdot {g}_{h , v}^{min} , D is set to 2 ; otherwise D is set to 1.$$

$$Step 4. If {g}_{d 0 , d 1}^{max} > {t}_{2} \cdot {g}_{d 0 , d 1}^{min} , D is set to 4 ; otherwise D is set to 3.$$

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as A.

For chroma components in a picture, no classification is applied.

### Geometric Transformations of Filter Coefficients and Clipping Values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 ) ,$$

$$Rotation : {f}_{R} ( k , l ) = f ( K - l - 1 , k ) , {c}_{R} ( k , l ) = c ( K - l - 1 , k ) ,$$

where K is the size of the filter and 0<k, l<K−1 are coefficients coordinates, such that location (0,0) is at the upper left corner and location (K−1, K−1) is at the lower right corner. The transformations are applied to the filter coefficientsf(k, l) and to the clipping values c(k, l) depending on gradient values calculated for that block. The relationship between the transformation and the four gradients of the four directions are summarized in the following table.

TABLE 1
Mapping of the gradient calculated for one block and the transformations

| Gradient values | Transformation | Transpose indexes |
|---|---|---|
| g_{d2} < g_{d1} and gₕ < gᵥ | No transformation | 0 |
| g_{d2} < g_{d1} and gᵥ < gₕ | Diagonal | 1 |
| g_{d1} < g_{d2} and gₕ < gᵥ | Vertical flip | 2 |
| g_{d1} < g_{d2} and gᵥ < gₕ | Rotation | 3 |

### Filtering Process

At decoder side, when ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7. )$$

where f(k, l) denotes the decoded filter coefficients, K(x, y) is the clipping function and c(k, l) denotes the decoded clipping parameters. The variable k and 1 varies between −L/2 and L/2, where L denotes the filter length. The clipping function K(x, y)=min (y, max(−y, x)) which corresponds to the function Clip3 (−y, y, x). The clipping operation introduces non-linearity to make ALF more efficient by reducing the impact of neighbour sample values that are too different with the current sample value.

### Cross Component Adaptive Loop Filter

CC-ALF uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include:
The design uses a 3×4 diamond shape with 8 taps.
Seven filter coefficients are transmitted in the APS.
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 << ( bitDepth - 1 ) ) - 16 and ( 1 << ( bitDeph - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes could be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ round ( {2}^{B - α * n} ) for n ∈ [ 0 … N - 1 ] \}$$

with B equal to the internal bitdepth, a is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −2⁷ to 2⁷-1, inclusive. The central position coefficient is not signalled in the bitstream and is considered as equal to 128.

### Adaptive Loop Filter in ECM

In ECM7 (Muhammed Coban, et al., “Algorithm description of Enhanced Compression Model 7 (ECM 7)”, Joint Video Experts Team (JVET) of ITU-T SG 16 WP 3 and ISO/IEC JTC 1/SC 29), 28th Meeting, Mainz, DE, 20-28 Oct. 2022, Document: JVET-AB2025), some changes from the VVC ALF are disclosed. A brief overview is shown below.

### ALF Simplification

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C₀, C₁ and C₂) and three different sets of filters (F₀, F₁ and F₂) are used. Sets F₀ and F₁ contain fixed filters, with coefficients trained for classifiers C₀ and C₁. Coefficients of filters in F₂ are signalled. Which filter from a set F₁ is used for a given sample is decided by a class Cᵢ assigned to this sample using classifier Cᵢ.

### Filtering

At first, two 13×13 diamond shape fixed filters F₀ and F₁ are applied to derive two intermediate samples R₀(x,y) and R₁(x,y). After that, F₂ is applied to R₀(x,y), R₁(x,y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x,y) and gᵢ is the clipped difference between Rᵢ₋₂₀(x,y) and current sample. The filter coefficients cᵢ, i=0, . . . 21, are signalled.

### Classification

Based on directionality Dᵢ and activity Âᵢ, a class Cᵢ is assigned to each 2×2 block:

$${C}_{i} = {\hat{A}}_{i} * {M}_{D , i} + {D}_{i} ,$$

where M_{D,j} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C₀ and the sum of sample gradients within a 12×12 window is used for classifiers C₁ and C₂. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength E and diagonal edge strength

$${E}_{D}^{i}$$

are calculated first. Thresholds Th=[1.25, 1.5, 2, 3, 4.5, 8] are used. Edge strength

$${E}_{H V}^{i} is 0 if {r}_{h , v}^{i} \leq T h [ 0 ] ;$$

otherwise

$${E}_{H V}^{i}$$

is the maximum integer such that

$${r}_{h , v}^{i} > T h [ {E}_{H V}^{i} - 1 ] .$$

Edge strength

$${E}_{D}^{i} is 0 if {r}_{d 1 , d 2}^{i} \leq Th [ 0 ] ;$$

i.e., otherwise,

$${E}_{D}^{i}$$

is the maximum integer such that

$${r}_{d 1 , d 2}^{i} > Th [ {E}_{D}^{i} - 1 ] . When {r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{H V}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{H V}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Â₂ and 15 for Â₀ and Â₁.

In an ALF_APS, up to 4 luma filter sets are signalled, each set may have up to 25 filters.

As mentioned above, in VVC and ECM ALF, cross-component taps are only applied to CCALF and only applied to luma-to-chroma taps. While there are 4 different sources for ALF, the class and geometric transform index are determined using only one of the sources, i.e., the pre-ALF samples. In the present invention, methods and apparatus to improve the performance are disclosed.

### BRIEF SUMMARY OF THE INVENTION

A method and apparatus for video coding using ALF (Adaptive Loop Filter) are disclosed. According to the method, reconstructed pixels are received, wherein the reconstructed pixels comprise a current block and each reconstructed pixel comprises multiple colour components. ALF processing is applied to a target colour component of the current block, wherein the ALF processing comprises colour-component ALF processing and cross-component ALF processing, the colour-component ALF processing is applied to the target colour component of the current block to generate the target colour component for a filtered-reconstructed current block, the cross-component ALF processing is applied to another colour component of the current block to generate across-component adjustment for the target colour component of the filtered-reconstructed current block, and wherein input data related to reconstructed pixels associated with at least two colour components are provided for the colour-component ALF processing and the cross-component ALF processing, and the colour-component ALF processing and the cross-component ALF processing use signalled coefficients. The filtered-reconstructed current block is provided and the across-component adjustment is provided to the target colour component of the filtered-reconstructed current block to generate a final filtered-reconstructed current block.

In one embodiment, the target colour component for the colour-component ALF processing corresponds to a first chroma component, and the input data related to the reconstructed pixels comprising a luma component are provided for the colour ALF processing. In one embodiment, the input data related to the reconstructed pixels further comprise the first chroma component and/or a second chroma component.

In one embodiment, the target colour component for the colour-component ALF processing corresponds to a luma component, and the input data related to the reconstructed pixels comprising a first chroma component are provided for the colour ALF processing. In one embodiment, a flag is signalled in APS (Adaptation Parameter Set), slice, picture header, SPS (Sequence Parameter Set), or PPS (Picture Parameter Set) to select between Cb or Cr component for the colour ALF processing.

In one embodiment, the colour-component ALF processing and the cross-component ALF processing use one or more APS (Adaptation Parameter Set) classifiers. In one embodiment, the signalled coefficients are selected according to said one or more APS classifiers.

In one embodiment, one or more differences between one or more neighbouring samples and a centre sample are used for the colour ALF processing, and wherein said one or more neighbouring samples correspond to a different colour component from the centre sample.

In one embodiment, the input data related to the reconstructed pixels provided for the cross-component ALF processing are from different stages. In one embodiment, the input data related to the reconstructed pixels provided for the cross-component ALF processing are from one or more stages comprising pre-DF (Deblocking Filter), pre-SAO (Sample Adaptive Offset), post-filtered samples or a combination thereof in addition to pre-ALF.

In one embodiment, when the colour-component ALF processing and the cross-component ALF processing are both used, coefficients and clipping indices for the colour-component ALF processing and the cross-component ALF processing are jointly optimized at an encoder side.

According to another method, reconstructed pixels are received, wherein the reconstructed pixels comprise a current block. An ALF is determined, wherein the ALF comprises multiple tap groups corresponding to multiple source types. A transformed ALF is derived by applying geometric transform to multiple footprints associated with the multiple tap groups of the ALF according to multiple geometric transform indices for the multiple tap groups respectively. A filtered-reconstructed current block is generated by applying the transformed ALF to the current block.

In one embodiment, the multiple source types correspond to spatial taps using pre-ALF samples, first fixed-filter based taps, second fixed-filter based taps, and pre-DF (Deblocking Filter) taps.

In one embodiment, at least two of the multiple geometric transform indices are determined based on at least two of the multiple source types separated.

In one embodiment, at least one of the multiple geometric transform indices is determined based on an already-determined geometric transform indices.

In one embodiment, the transformed ALF is derived by an additional geometric transform that performs coefficient rotation of the ALF across the multiple tap groups.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ(3A), gₕ(3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates the footprints for the ECM ALF according to tap groups.

FIG. 6 illustrates a flowchart of an exemplary video coding system that applies ALF with multiple-component inputs to the colour component ALF processing or cross-component ALF processing according to an embodiment of the present invention.

FIG. 7 illustrates a flowchart of an exemplary video coding system that applies ALF with separate geometric transform or cross-source geometric transformaccording to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Luma ALF, Chroma ALF, and/or CCALF with Cross-Component Taps

In ECM ALF, cross-component taps are only applied to CCALF and only applied to luma-to-chroma taps. In this disclosure, several luma ALF, chroma ALF, or CCALF with cross-component taps schemes are illustrated. For convenience, the luma ALF and the chroma ALF are also referred as colour-component ALF in order to be distinguished from the CCALF in this disclosure.

### Chroma ALF:

In one embodiment, to utilize the luma samples to chroma ALF filtering process with signalled coefficients, the following steps can be applied:
Chroma filtering process by signalled coefficients with the chroma and luma samples

In above embodiment, to utilize the Cr samples to Cb ALF filtering process or Cb samples to Cr ALF filtering process with signalled coefficients, the following steps can be applied:
Chroma filtering process by signalled coefficients with the chroma samples of Cb and Cr

In above embodiment, classification by APS classifiers can also be applied:
Chroma classification by APS classifiers
Chroma filtering process by signalled coefficients with the chroma and luma samples, the classification by APS classifiers is used to select signalled coefficients

In above embodiment, the differences between neighbouring samples and centre sample in the filtering process (R(i+k,j+l)−R(i,j)) can be different components.

### Example

Cb filtering process by signalled coefficients with the Cb and luma samples,
Cr filtering process by signalled coefficients with the Cr and luma samples

### Example

Cb filtering process by signalled coefficients with the Cb and Cr samples
Cr filtering process by signalled coefficients with the Cb and Cr samples

### Example

Cb filtering process by signalled coefficients with the Cb, Cr, and luma samples
Cr filtering process by signalled coefficients with the Cb, Cr, and luma samples

### Example

Cb classification by APS classifiers
Cb filtering process by signalled coefficients with the Cb and luma samples, the classification by APS classifiers is used to select signalled coefficients
Cr classification by APS classifiers
Cr filtering process by signalled coefficients with the Cr and luma samples, the classification by APS classifiers is used to select signalled coefficients

### Example

Cb classification by APS classifiers
Cb filtering process by signalled coefficients with the Cb and Cr samples, the classification by APS classifiers is used to select signalled coefficients
Cr classification by APS classifiers
Cr filtering process by signalled coefficients with the Cb and Cr samples, the classification by APS classifiers is used to select signalled coefficients

### Example

Cb filtering process by signalled coefficients with the differences between neighbouring Cb samples and centre Cb sample and the differences between neighbouring luma samples and centre luma sample
Cr filtering process by signalled coefficients with the differences between neighbouring Cr samples and centre Cr sample and the differences between neighbouring luma samples and centre luma sample

### Example

Cb filtering process by signalled coefficients with the differences between neighbouring Cb samples and centre Cb sample and the differences between neighbouring luma samples and centre Cb sample
Cr filtering process by signalled coefficients with the differences between neighbouring Cr samples and centre Cr sample and the differences between neighbouring luma samples and centre Cr sample

### Example

Cb filtering process by signalled coefficients with the differences between neighbouring Cb samples and centre Cb sample and the differences between neighbouring Cr samples and centre Cr sample
Cr filtering process by signalled coefficients with the differences between neighbouring Cr samples and centre Cr sample and the differences between neighbouring Cb samples and centre Cb sample

### Example

Cb filtering process by signalled coefficients with the differences between neighbouring Cb samples and centre Cb sample and the differences between neighbouring Cr samples and centre Cb sample
Cr filtering process by signalled coefficients with the differences between neighbouring Cr samples and centre Cr sample and the differences between neighbouring Cb samples and centre Cr sample

### Luma ALF:

In one embodiment, to utilize the chroma samples to luma ALF filtering process with signalled coefficients, the following steps could be applied:
Luma classification by APS classifiers
Luma filtering process by signalled coefficients with the luma and chroma samples, the classification by APS classifiers is used to select signalled coefficients

In above embodiment, a flag can be signalled in bitstream in APS, slice, picture header, SPS (Sequence Parameter Set), or PPS (Picture Parameter Set), to select between Cb or Cr component, and utilize the samples of selected chroma component to luma ALF filtering process with signalled coefficients

In above embodiment, the differences between neighbouring and centre samples in filtering process (R1(i+k,j+l)−R2(i, j)) can be different components.

### Example

Luma filtering process by signalled coefficients with the luma and Cb and Cr samples, the classification by APS classifiers is used to select signalled coefficients

### Example

Luma filtering process by signalled coefficients with the luma and Cb samples, the classification by APS classifiers is used to select signalled coefficients

### Example

Luma filtering process by signalled coefficients with the luma and Cr samples, the classification by APS classifiers is used to select signalled coefficients

### Example

Luma filtering process by signalled coefficients with the luma samples and samples of selected chroma component by flag, the classification by APS classifiers is used to select signalled coefficients

### Example

Luma filtering process by signalled coefficients with the differences between neighbouring luma samples and centre luma sample, the differences between neighbouring Cb samples and centre Cb sample, and the differences between neighbouring Cr samples and centre Cr sample

### Example

Luma filtering process by signalled coefficients with the differences between neighbouring luma samples and centre luma sample, the differences between neighbouring Cb samples and centre luma sample, and the differences between neighbouring Cr samples and centre luma sample

### CCALF:

In one embodiment, to utilize the chroma samples to CCALF filtering process with signalled coefficients, the following steps can be applied:
Chroma filtering process by signalled coefficients with the luma and chroma samples

In above embodiment, to utilize the Cr samples to Cb CCALF filtering process or Cb samples to Cr CCALF filtering process with signalled coefficients.

In above embodiment, the differences between neighbouring and centre samples in filtering process (R1(i+k, j+l)−R2(i, j)) can be different components.

### Example

Cb filtering process by signalled coefficients with the luma and Cb samples
Cr filtering process by signalled coefficients with the luma and Cr samples

### Example

Cb filtering process by signalled coefficients with the luma and Cr samples
Cr filtering process by signalled coefficients with the luma and Cb samples

### Example

Cb filtering process by signalled coefficients with the luma and Cb and Cr samples
Cr filtering process by signalled coefficients with the luma and Cb and Cr samples

### Example

Cb filtering process by signalled coefficients with the differences between neighbouring luma samples and centre luma sample and the differences between neighbouring Cb samples and centre Cb sample
Cr filtering process by signalled coefficients with the differences between neighbouring luma samples and centre luma sample and the differences between neighbouring Cr samples and centre Cr sample

### Example

Cb filtering process by signalled coefficients with the differences between neighbouring luma samples and centre luma sample, the differences between neighbouring Cb samples and centre Cb sample, and the differences between neighbouring Cr samples and centre Cr sample
Cr filtering process by signalled coefficients with the differences between neighbouring luma samples and centre luma sample, the differences between neighbouring Cb samples and centre Cb sample, and the differences between neighbouring Cr samples and centre Cr sample

### Example

Cb filtering process by signalled coefficients with the differences between neighbouring luma samples and centre Cb sample and the differences between neighbouring Cb samples and centre luma sample
Cr filtering process by signalled coefficients with the differences between neighbouring luma samples and centre Cr sample and the differences between neighbouring Cr samples and centre luma sample

### Example

Cb filtering process by signalled coefficients with the differences between neighbouring luma samples and centre luma sample, the differences between neighbouring Cb samples and centre luma sample, and the differences between neighbouring Cr samples and centre luma sample
Cr filtering process by signalled coefficients with the differences between neighbouring luma samples and centre luma sample, the differences between neighbouring Cb samples and centre luma sample, and the differences between neighbouring Cr samples and centre luma sample

In the above embodiments, the samples of each component from different stages can be used. That is, in addition to pre-ALF samples, pre-DF, pre-SAO, or post-filtered samples can be used in the proposed ALF with cross-component taps.

### Example

### Luma ALF:

Luma filtering process by signalled coefficients with the pre-ALF luma and pre-DF Cb and/or Cr samples, the classification by APS classifiers is used to select signalled coefficients

### Chroma ALF:

Cb filtering process by signalled coefficients with the pre-ALF Cb and pre-SAO luma samples
Cr filtering process by signalled coefficients with the pre-ALF Cr and pre-SAO luma samples

### CCALF:

Cb filtering process by signalled coefficients with the pre-ALF luma and post-ALF Cb samples
Cr filtering process by signalled coefficients with the pre-ALF luma and post-ALF Cr samples

In one embodiment, coefficients and clipping indices of cross-component taps are jointly optimized with those of other taps.

ALF with Separate Class and Geometric Transform

In ECM, ALF reconstruction formula can be written as:

$$\tilde{R} ( x , y ) = R ( x , y ) + [ {\sum }_{i = 0}^{A - 1} {c}_{i} {n}_{i} ] + [ {\sum }_{i = A}^{A + B - 1} {c}_{i} {n}_{i} ] + [ {\sum }_{i = A + B}^{A + B + C - 1} {c}_{i} {n}_{i} ] + [ {\sum }_{i = A + B + C}^{A + B + C + D - 1} {c}_{i} {n}_{i} ] ,$$

where R(x,y) is the sample value before ALF filtering, R(x,y) is the sample value after ALF filtering, cᵢ is the i-th filter coefficient, and nᵢ is the i-th filter tap input. Specifically, for i=0, . . . , A−1, nᵢ is a clipped difference between pre-ALF samples and R(x, y); for i=A, . . . , A+B-1, nᵢ is a clipped difference between samples filtered by fixed filter set 0 and R(x,y); for i=A+B, . . . ,A+B+C−1, nᵢ is a clipped difference between samples filtered by fixed filter set 1 and R(x, y); for i=A+B+C, . . . ,A+B+C+D−1, nᵢ is a clipped difference between samples before deblocking filtering (pre-DBF) and R(x, y).

In such design, taps can be categorized into 4 tap groups based on the input source. However, although there are 4 different sources, the class and geometric transform index are determined using only one of the sources, i.e., the pre-ALF samples. That is, the filter coefficient (c₁) selection and the footprint rotation for all taps are totally determined based on pre-ALF samples. In this disclosure, the class index or the geometric transform index can be determined separately for each tap group.

In the following sections, tap group 0 refers to the set of taps with i=0, . . . , A−1, tap group 1 refers to the set of taps with i=A, . . . , A+B−1, tap group 2 refers to the set of taps with i=A+B, . . . , A+B+C−1, and tap group 3 refers to the set of taps with i=A+B+C, . . . ,A+B+C+D−1.

$$\tilde{R} ( x , y ) = R ( x , y ) + [ {\sum }_{i = 0}^{A - 1} {c}_{i} {n}_{i} ] + [ {\sum }_{i = A}^{A + B - 1} {c}_{i} {n}_{i} ] + [ {\sum }_{i = A + B}^{A + B + C - 1} {c}_{i} {n}_{i} ] + [ {\sum }_{i = A + B + C}^{A + B + C + D - 1} {c}_{i} {n}_{i} ]$$

In the above equation, the term in the first pair of bracket corresponds to tap group 0, the term in the second pair of bracket corresponds to tap group 1, the term in the third pair of bracket corresponds to tap group 2, the term in the fourth pair of bracket corresponds to tap group 3.

ALF with Separate Class

In one embodiment, the class index of each tap group is determined by using the corresponding source. Specifically, 4 class indices cid₀, cid₁, cid₂, and cid₃ are derived using pre-ALF samples, samples filtered by fixed filter set 0, samples filtered by fixed filter set 1, and pre-DBF samples, respectively. The class index cidk is used to select the filter coefficients for taps in tap group k, and k=0, . . . , 3.

In another embodiment, the class indices of some tap groups are determined by using the corresponding source, while the class indices of the other tap groups follow one of the already-determined class indices. For example, 2 class indices cid₀ and cid₁ are derived using pre-ALF samples and samples filtered by fixed filter set 0, respectively. The class index cid₀ is used to select the filter coefficients for taps in tap group 0 and tap group 3, and the class index cidₗ is used to select the filter coefficients for taps in tap group 1 and tap group 2.

ALF with Separate Geometric Transform

In ECM, a common geometric transform index is derived using pre-ALF samples and the geometric transform is applied to tap group 0 and tap group 1 according to the index. In this section, some designs of separate geometric transform are introduced.

In one embodiment, the geometric transform index of each tap group is determined by using the corresponding source. Specifically, 4 geometric transform indices gid₀, gid₁, gid₂, and gid₃ are derived using pre-ALF samples, samples filtered by fixed filter set 0, samples filtered by fixed filter set 1, and pre-DBF samples, respectively. The geometric transform index gidₖ is used to determine how to rotate filter footprint for taps in tap group k.

In another embodiment, the geometric transform indices of some tap groups are determined by using the corresponding source, while the geometric transform indices of the other tap groups follow one of the already-determined geometric transform indices. For example, 2 geometric transform indices gid₀ and gid₁ are derived using pre-ALF samples and samples filtered by fixed filter set 0, respectively. The geometric transform index gid₀ is used to determine how to rotate filter footprint for taps in tap group 0 and tap group 3, and the geometric transform index gid₁ is used to determine how to rotate filter footprint for taps in tap group 1 and tap group 2.

### ALF With Cross-Source Geometric Transform

In ECM, when applying geometric transform to tap group 0 and tap group 1, the coefficient rotation is performed on the same source. That is, after the rotation, a coefficient in tap group k can only be swapped for another coefficient also in tap group k but not for any coefficients in other tap groups. In this section, it is disclosed that the coefficient rotation can be performed across different tap groups.

In one embodiment, coefficients in different tap groups can be reordered together. An example based on ECM ALF is illustrated below.

### Example

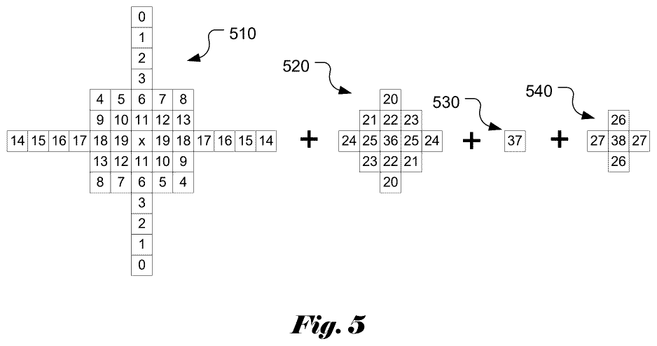

The ECM ALF filter footprints are shown in FIG. 5, where tap group 0(510), tap group 1 (520), tap group 2 (530) and tap group 3 (540) are shown.

In ECM, there are 4 sources used in ALF, including pre-ALF samples (corresponding to tap 0-19), samples filtered by fixed filter set 0 (corresponding to tap 20-25, and 36), samples filtered by fixed filter set 1 (corresponding to tap 37), pre-DBF samples (corresponding to tap 26, 27, and 38). When ALF is applied, a geometric transform index g₀ is determined based on the sample difference statistics of the pre-ALF source, and the geometric transform is separately applied to both tap group 0 (pre-ALF-based taps) and tap group 1(fixed-filter-set-O-based taps) based on g₀. For tap group 0 (tap 0-19), the following geometric transforms are applied.
If g₀ is 0, no coefficient reordering.
If g₀ is 1, reorder to {14, 15, 16, 17, 4, 9, 18, 13, 8, 5, 10, 19, 12, 7, 0, 1, 2, 3, 6, 11}.
If g₀ is 2, reorder to {0, 1, 2, 3, 8, 7, 6, 5, 4, 13, 12, 11, 10, 9, 14, 15, 16, 17, 18, 19}.
If g₀ is 3, reorder to {14, 15, 16, 17, 8, 13, 18, 9, 4, 7, 12, 19, 10, 5, 0, 1, 2, 3, 6, 11}.

For tap group 1(tap 20-25), the following coefficient reordering is applied.
If g₀ is 0, no coefficient reordering.
If g₀ is 1, reorder to {24, 21, 25, 23, 20, 22}.
If g₀ is 2, reorder to {20, 23, 22, 21, 24, 25}.
If g₀ is 3, reorder to {24, 23, 25, 21, 20, 22}.

In the embodiment, the reordering can be across the sources. Specifically, another geometric transform index g₁ is determined based on sample difference statistics between pre-ALF source and fixed-filter-set-0 result, and the geometric transform is applied to tap group 0 and 1 jointly based on g₁. For example:
If g₁ is 0, no coefficient reordering.
If g₁ is 1, swap the taps {6, 10, 11, 12, 18, 19} for {20, 21, 22, 23, 24, 25}.

Note that this geometric transform can be performed additionally on top of the existing geometric transform, and there may be more than one option of how to perform the geometric transform. In such case, the geometric transform type selection can be explicitly signalled at APS-level, filter-set-level, filter-level, or be implicitly determined by classifier selection.

ALF Classifier with Diversified Source

In ECM ALF, a filter set selects between a VVC-like gradient-based classifier and a band classifier. Different classifiers provide different grouping results of blocks in a frame, and different grouping results lead to different derived filter sets and corresponding optimized sum-of-square distortion (SSD) values. Therefore, adding more classifiers enables ALF to explore more ways to distribute filters to blocks. In this proposal, several classification ideas and methods are illustrated.

### Transpose Index Classifier

In one embodiment, transpose index is used to derive the class. In such design, the transpose index not only determines how to rotate the filter coefficients and clipping, but also determines the class index. For example, a 4-class classifier can be defined by:

$$classIndex = transposeIndex .$$

Band Classifier with Various Inputs

In ECM, band classifier is performed by calculating the average value of pre-ALF samples in a block. In this section of the proposal, sources other than pre-ALF samples are used to derive the class in the band classifier.

In one embodiment, the average value of fixed-filtered samples in a block is calculated to derive the class. For example, an N-class band classifier is defined by:

$$classIndex = ( N * fixed filtered sample sum ) >> ( bitdepth + 2 ) ,$$

where bitdepth is the bitdepth of the samples, and a right-shift value 2 is used since 2×2 block size is assumed here (sum of 4 samples).

In another embodiment, the average values of both pre-ALF samples and fixed-filtered samples in a block are calculated and used to derive the class. For example, an N-class band classifier is defined by:

$$classIndex = ( N * ( preALF sample sum + fixed filtered sample sum ) ) >> ( bitdepth + 3 ) ,$$

where the bitdepth is the bitdepth of the samples, and a right-shift value 3 is used since 2×2 block size is assumed here (sum of 8 samples).

In the above embodiment, sources used for deriving ALF tap inputs can all or partially be used for classification. For example, if ALF tap inputs are derived by using pre-deblocking-filtered (pre-DBF) samples, pre-ALF samples, samples filtered by fixed filter set 0, samples filtered by fixed filter set 1, reference frame collocated samples, and residual samples, the classifier could be like:

$$classIndex = ( N * average of ( \begin{matrix}preDBF sample sum , \\ preALF sample sum , \\ sample filtered by fixed filter set 0 sum , \\ s ample filtered by fixed filter set 1 sum , \\ r e f e rence frame collocated samples , \\ r e s idual samples\end{matrix} ) >> ( bitdepth + 2 ) .$$

Note that in such design, the classifier can be dependent on the filter tap source selection.

Gradient-Based Classifier with Various Inputs

In ECM, gradient-based classifier is performed by calculating the gradient statistics (i.e., Laplacian) of pre-ALF samples. In this section of the disclosure, sources other than pre-ALF samples are used to derive the class in gradient-based classifier.

In one embodiment, the fixed-filtered samples are used to replace the pre-ALF samples for class derivation. In another embodiment, the pre-ALF and the fixed-filtered samples and are used to derive the class. In another embodiment, sources used for deriving ALF tap inputs can all or partially be used to derive the class.

### CU-Coding-Information-Based Classifier

In one embodiment, for each sample at position (x, y), the distance to a CU boundary is used to derive the class. For example, a 2-class classifier is defined by: classIndex=((x,y) is near a CU boundary) ?1:0.

In another embodiment, for each sample at position (x, y), the residual value is used to derive the class. For example, a 2-class classifier is defined by:

$$classIndex = ( Residual at ( x , y ) is smaller than a threshold T ) ? 1 \text{:} 0 ,$$

where threshold T is a fixed pre-determined value. Note that an N-class classifier (N>2) can be used to cover more different T values. For example, a 5-class classifier is defined by:

$$classIndex = ( ( x , y ) is near a CU boundary ) ? 1 \text{:} 0.$$

$$classIndex == 0 , if ( Residual at ( x , y ) < {T}_{0} ) ,$$

$$classIndex == 1 , if ( {T}_{0} \leq Residual at ( x , y ) < {T}_{1} ) ,$$

$$classIndex == 2 , if ( {T}_{1} \leq Residual at ( x , y ) < {T}_{2} ) ,$$

$$classIndex == 3 , if ( {T}_{2} \leq Residual at ( x , y ) < {T}_{3} ) ,$$

$$classIndex == 4 , otherwise .$$

In another embodiment, for each sample at position (x, y), the motion vector is used to derive the class. For example, a 4-class classifier is defined by:

$${c}_{x} = ( Mvx at ( x , y ) is smaller than a threshold T ) ? 1 \text{:} 0$$

$${c}_{y} = ( Mvy at ( x , y ) is smaller than a threshold T ) ? 1 \text{:} 0$$

$$classIndex = {c}_{x} * 2 + {c}_{y} ,$$

where threshold T is a fixed pre-determined value. Note that an N-class classifier (N>4) can be used to cover more different cover more different T values.

In another embodiment, for each sample at position (x, y), the inter-mode direction is used to derive the class. For example, a 3-class classifier is defined by:

$$classIndex == 0 , if inter dir at ( x , y ) is L 0$$

$$classIndex == 1 , if inter dir at ( x , y ) is L 1$$

$$classIndex == 2 , if inter dir at ( x , y ) is Bi .$$

For the above embodiments, it is applicable for either sample-based classification or block-based classification. If block-based classification is used, one of the samples in a block (e.g., the left-top sample) is taken as representative of the entire block for adaptation to the above embodiments.

### Multiple-Stage-Data Classifier

In one embodiment, the class index is derived based on two sub-class indices. One sub-class index preDbfIdx is derived by using pre-DBF samples, while the other sub-class index preAlfIdx is derived by using pre-ALF samples. The final class index is derived by:

$$classIndex = M * preDbfIdx + preAlfIdx ,$$

where M is the number of sub-classes derived from pre-ALF samples.

In another embodiment, one sub-class index preAlfIdx is derived by using pre-ALF samples, while the other sub-class index diffIdx is derived by using the difference between pre-DBF and pre-ALF samples. The final class index is derived by:

$$classIndex = M * diffIdx + preAlfIdx ,$$

where M is the number of sub-classes derived from pre-ALF samples.

In the foregoing proposed methods, when there is a threshold used in classification with “difference between two sources (e.g., pre-DBF samples, pre-ALF samples, . . . )” or “residual,” the threshold can be dependent on QP and bitdepth of the source.

The foregoing proposed methods can be combined. For example, derive a first class index c₁ using one M-class classifier method, and derive a second class index c₂ using another N-class classifier method. The final classifier is a M*N-class classifier with the class index determined by either:

$$classIndex = N * {c}_{1} + {c}_{2} ,$$

$$or$$

$$classIndex = M * {c}_{2} + {c}_{1} .$$

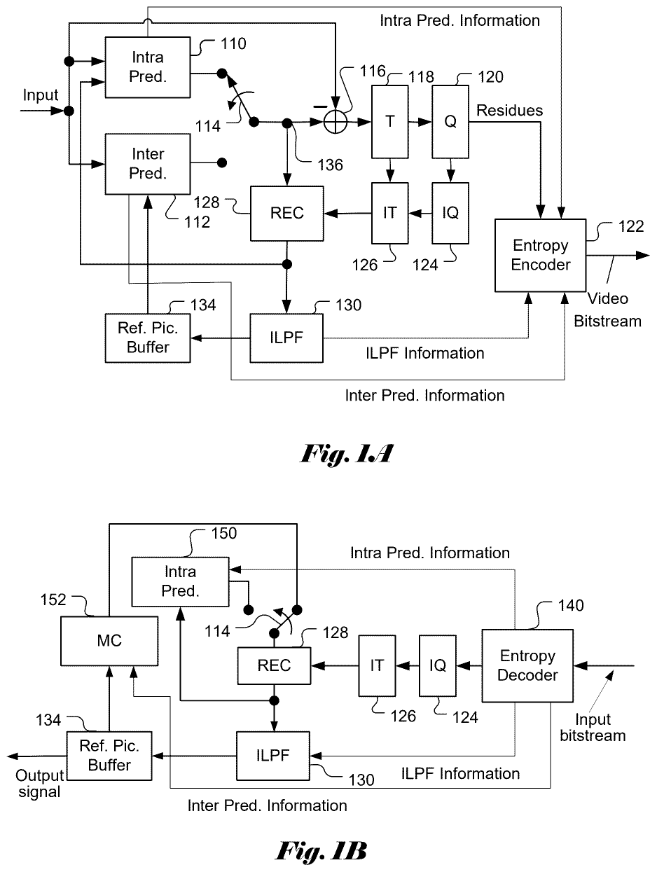

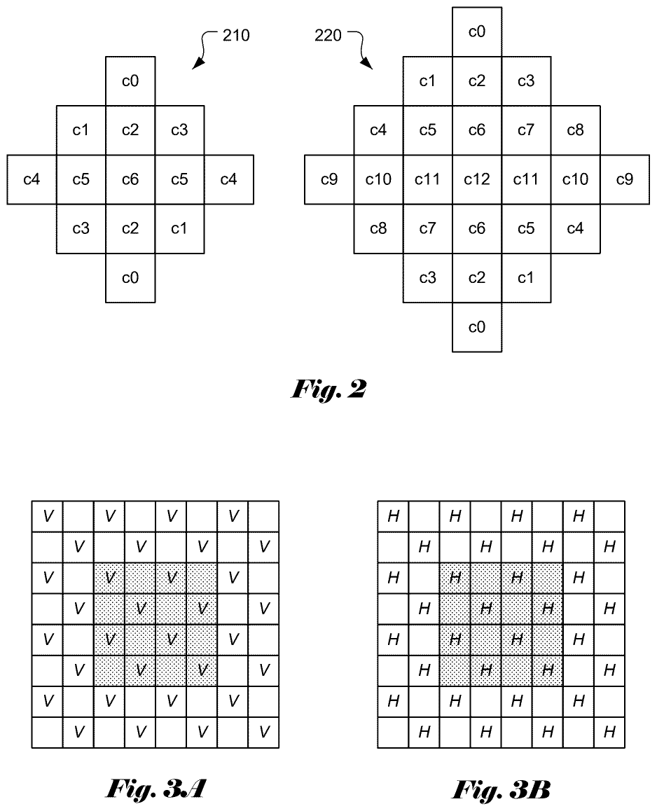

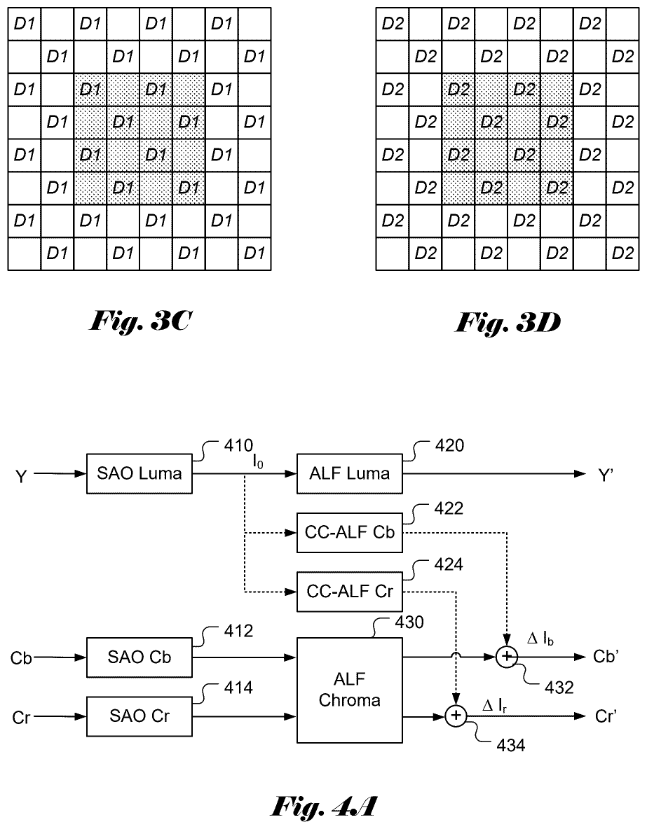

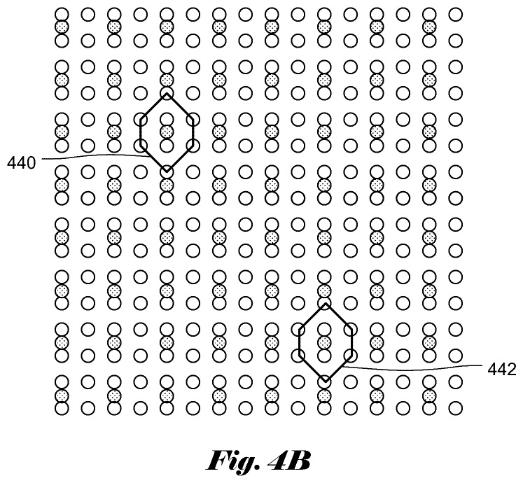

Any of the ALF methods with multiple colour component inputs to the colour component ALF and/or CCALF described above can be implemented in encoders and/or decoders. Also, any of the ALF methods with separate geometric transform and/or cross-source geometric transform described above can be implemented in encoders and/or decoders. For example, any of the proposed methods can be implemented in the in-loop filter module (e.g. ILPF 130 in FIG. 1A and FIG. 1B) of an encoder or a decoder. Alternatively, any of the proposed methods can be implemented as a circuit coupled to the inter coding module of an encoder and/or motion compensation module, a merge candidate derivation module of the decoder. The ALF methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

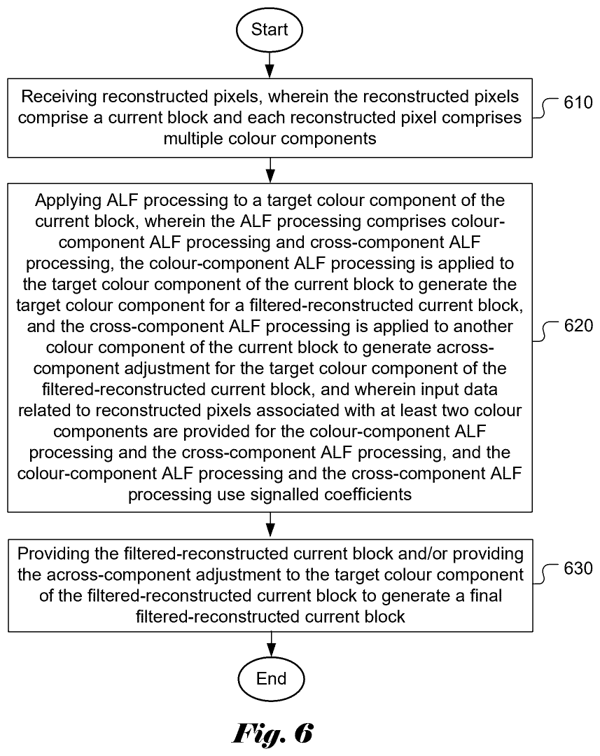

FIG. 6 illustrates a flowchart of an exemplary video coding system that applies ALF with multiple-component inputs to the colour component ALF processing or cross-component ALF processing according to an embodiment of the present invention The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, reconstructed pixels are received in step 610, wherein the reconstructed pixels comprise a current block and each reconstructed pixel comprises multiple colour components. ALF processing is applied to a target colour component of the current block in step 620, wherein the ALF processing comprises colour-component ALF processing and cross-component ALF processing, the colour-component ALF processing is applied to the target colour component of the current block to generate the target colour component for a filtered-reconstructed current block, and the cross-component ALF processing is applied to another colour component of the current block to generate across-component adjustment for the target colour component of the filtered-reconstructed current block, and wherein input data related to reconstructed pixels associated with at least two colour components are provided for the colour-component ALF processing and the cross-component ALF processing, and the colour-component ALF processing and the cross-component ALF processing use signalled coefficients. The filtered-reconstructed current block is provided and/or the across-component adjustment is provided to the target colour component of the filtered-reconstructed current block to generate a final filtered-reconstructed current block in step 630.

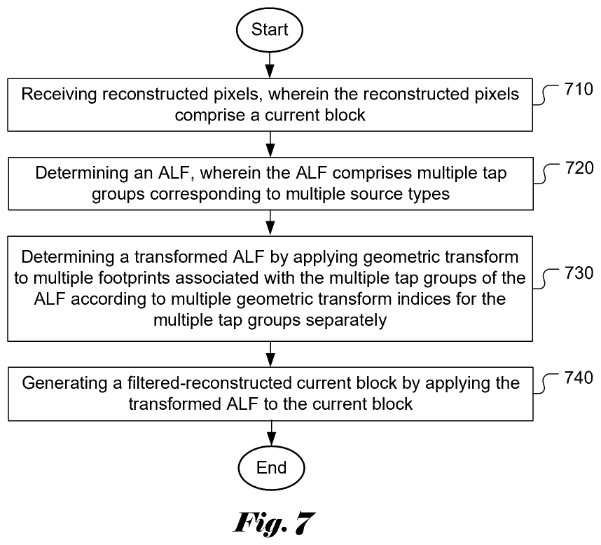

FIG. 7 illustrates a flowchart of an exemplary video coding system that applies ALF with separate geometric transform or cross-source geometric transformaccording to an embodiment of the present invention. According to another method, reconstructed pixels are received in step 710, wherein the reconstructed pixels comprise a current block. An ALF is determined in step 720, wherein the ALF comprises multiple tap groups corresponding to multiple source types. A transformed ALF is derived by applying geometric transform to multiple footprints associated with the multiple tap groups of the ALF according to multiple geometric transform indices for the multiple tap groups respectively in step 730. A filtered-reconstructed current block is generated by applying the transformed ALF to the current block in step 740.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for Adaptive Loop Filter (ALF) processing of reconstructed video, the method comprising:
receiving reconstructed pixels, wherein the reconstructed pixels comprise a current block and each reconstructed pixel comprises multiple colour components;
applying ALF processing to a target colour component of the current block, wherein the ALF processing comprises colour-component ALF processing and cross-component ALF processing, the colour-component ALF processing is applied to the target colour component of the current block to generate the target colour component for a filtered-reconstructed current block, and the cross-component ALF processing is applied to another colour component of the current block to generate across-component adjustment for the target colour component of the filtered-reconstructed current block, and wherein input data related to reconstructed pixels associated with at least two colour components are provided for the colour-component ALF processing and the cross-component ALF processing, and the colour-component ALF processing and the cross-component ALF processing use signalled coefficients; and
providing the filtered-reconstructed current block and providing the across-component adjustment to the target colour component of the filtered-reconstructed current block to generate a final filtered-reconstructed current block.

2. The method of claim 1, wherein the target colour component for the colour-component ALF processing corresponds to a first chroma component, and the input data related to the reconstructed pixels comprising a luma component are provided for the colour ALF processing.

3. The method of claim Error! Reference source not found, wherein the input data related to the reconstructed pixels further comprise the first chroma component and/or a second chroma component.

4. The method of claim 1, wherein the target colour component for the colour-component ALF processing corresponds to a luma component, and the input data related to the reconstructed pixels comprising a first chroma component are provided for the colour ALF processing.

5. The method of claim Error! Reference source not found, wherein a flag is signalled in APS (Adaptation Parameter Set), slice, picture header, SPS (Sequence Parameter Set), or PPS (Picture Parameter Set) to select between Cb or Cr component for the colour ALF processing.

6. The method of claim 1, wherein the colour-component ALF processing and the cross-component ALF processing use one or more APS (Adaptation Parameter Set) classifiers.

7. The method of claim Error! Reference source not found, wherein the signalled coefficients are selected according to said one or more APS classifiers.

8. The method of claim 1, wherein one or more differences between one or more neighbouring samples and a centre sample are used for the colour ALF processing, and wherein said one or more neighbouring samples correspond to a different colour component from the centre sample.

9. The method of claim 1, wherein the input data related to the reconstructed pixels provided for the cross-component ALF processing are from different stages.

10. The method of claim Error! Reference source not found, wherein the input data related to the reconstructed pixels provided for the cross-component ALF processing are from one or more stages comprising pre-DF (Deblocking Filter), pre-SAO (Sample Adaptive Offset), post-filtered samples or a combination thereof in addition to pre-ALF.

11. The method of claim 1, wherein coefficients and clipping indices for the colour-component ALF processing and the cross-component ALF processing are jointly optimized at an encoder side.

12. An apparatus for video coding, the apparatus comprising one or more electronics or processors arranged to:
receive reconstructed pixels, wherein the reconstructed pixels comprise a current block and each reconstructed pixel comprises multiple colour components;
apply ALF processing to a target colour component of the current block, wherein the ALF processing comprises colour-component ALF processing and cross-component ALF processing, the colour-component ALF processing is applied to the target colour component of the current block to generate the target colour component for a filtered-reconstructed current block, and the cross-component ALF processing is applied to another colour component of the current block to generate across-component adjustment for the target colour component of the filtered-reconstructed current block, and wherein input data related to reconstructed pixels associated with at least two colour components are provided for the colour-component ALF processing and the cross-component ALF processing, and the colour-component ALF processing and the cross-component ALF processing use signalled coefficients; and
provide the filtered-reconstructed current block and providing the across-component adjustment to the target colour component of the filtered-reconstructed current block to generate a final filtered-reconstructed current block.

13. A method for Adaptive Loop Filter (ALF) processing of reconstructed video, the method comprising:
receiving reconstructed pixels, wherein the reconstructed pixels comprise a current block;
determining an ALF, wherein the ALF comprises multiple tap groups corresponding to multiple source types;
determining a transformed ALF by applying geometric transform to multiple footprints associated with the multiple tap groups of the ALF according to multiple geometric transform indices for the multiple tap groups separately; and
generating a filtered-reconstructed current block by applying the transformed ALF to the current block.

14. The method of claim Error! Reference source not found, wherein the multiple source types correspond to spatial taps using pre-ALF samples, first fixed-filter based taps, second fixed-filter GC based taps, and pre-DF (Deblocking Filter) taps.

15. The method of claim 13, wherein at least two of the multiple geometric transform indices are determined based on at least two of the multiple source types respectively.

16. The method of claim Error! Reference source not found, wherein at least one of the GC multiple geometric transform indices is determined based on an already-determined geometric transform indices.

17. The method of claim 13, wherein the transformed ALF is determined by an additional geometric transform that performs coefficient rotation of the ALF across the multiple tap groups.

18. An apparatus for video coding, the apparatus comprising one or more electronics or processors arranged to:
receive reconstructed pixels, wherein the reconstructed pixels comprise a current block;
determine an ALF, wherein the ALF comprises multiple tap groups corresponding to multiple source types;
determine a transformed ALF by applying geometric transform to multiple footprints associated with the multiple tap groups of the ALF according to multiple geometric transform indices for the multiple tap groups separately; and
generate a filtered-reconstructed current block by applying the transformed ALF to the current block.
